(19) United States
(12) Patent Application Publication
(10) Pub. No.: US 2023/0411919 A1
(43) Pub. Date: Dec. 21, 2023

(54) Method for Producing a Charging Connector and a Charging Connector

(71) Applicant: ABB E-mobility B.V., Delft (NL)

(72) Inventors: Francisco Garcia-Ferre, Baden (CH); Clemens Van-Der-Veer, Zaandam (NL); Ali Ugur, Den Haag (NL)

(73) Assignee: ABB E-mobility B.V., Delft (NL)

(21) Appl. No.: 18/318,274

(22) Filed: May 16, 2023

(30) Foreign Application Priority Data
May 17, 2022 (EP) 22173854.5

(51) Int. Cl. H01R 43/24; H01R 13/533; H01R 43/00

(52) U.S. Cl. CPC H01R 43/24; H01R 2201/26; H01R 43/005; H01R 13/533

(57) ABSTRACT

A method for producing a charging connector includes providing a first thermoplastic material; thermoforming the first thermoplastic material into a reinforcement element, wherein the reinforcement element corresponds to a geometry of the charging connector; placing the reinforcement element into a mould for injection moulding; and forming at least a part of the charging connector by injection over molding the reinforcement element with a second thermoplastic material.

### CROSS-REFERENCE TO RELATED APPLICATIONS

This patent application claims priority to European Patent Application No. 22173854.5, filed on May 17, 2022, which is incorporated herein in its entirety by reference.

### FIELD OF THE DISCLOSURE

The present invention relates to a method for producing a charging connector and a respective charging connector, in particular a charging connector for an electric vehicle.

### BACKGROUND OF THE INVENTION

Charging connectors, especially EV charging connectors or CCS (Combined Charging System) connectors, have high standards in quality and safety. Possible mechanical failures may be related to defects in the material and may reveal the inner electrical components. Environmental influences such as water, dust and humidity must be kept away from the inside of the connector. Water entering the connector may induce corrosion of contacts, and the corrosion products may increase leakage currents along the creepage path between the contacts. The conductive path created may enhance partial discharge effects or tracking, leading to sudden flashover and fatal failure of the connector. As a result, current connectors have a low life cycle, especially if a damage occurs due to external mechanical forces or material fatigue.

It has now become apparent that there is a further need to provide an improved method for producing a charging connector and to provide a respective charging connection.

In view of the above, it is an object of the present invention to provide a method for producing a charging connector. It is in particular an object of the present invention to provide a method for producing a charging connector, which is more robust towards mechanical damage, and a charging connector produced by said method. These and other objects, which become apparent upon reading the following description, are solved by the subject matter of the independent claims. The dependent claims refer to preferred embodiments of the invention.

### BRIEF SUMMARY OF THE INVENTION

According to a first aspect of the present invention, a method for producing a charging connector is disclosed, wherein the method comprises: Providing a first thermoplastic material; Thermoforming the first thermoplastic material into a reinforcement element, wherein the reinforcement element corresponds to a geometry of the charging connector; Placing the reinforcement element into a mold for injection molding; and Forming at least a part of the charging connector by injection over molding the reinforcement element with a second thermoplastic material.

The term charging connector is to be understood broadly. The charging connector may be a charging connector for an electric vehicle. For example, a CCS type 1 or a CCS type 2 charging connector. However, the present disclosure is not limited to a specific charging connector type, i.e. other charging connectors are possible.

The first thermoplastic material is used to produce the reinforcement element. The shape of the reinforcement element may correspondent to any shape or geometry of the final charging connector. The reinforcement element may be shaped corresponding to an area of the charging connector, which is often exposed to mechanical stress. Other areas are possible.

The reinforcement element is thermoformed. Thermoforming is an easy and cheap process to form a thermoplastic material into a desired form. Thermoforming allows forming of the first thermoplastic material without changing the orientation of the fibers. In this way, the thickness of the first thermoplastic material region may be chosen, as well as the exact geometry.

Then the reinforcement element is arranged in the mold where the charging connector or at least a part of the charging connector is formed by injection molding. Injection molding is very suitable for geometries that are more complex. The reinforcement element is arranged at an intended position in the mold. The intended position of the reinforcing element is the position corresponding to the charging connector geometry that is to be reinforced.

When injection molding, the reinforcement element is combined with the charging connector. This process is called over molding. The area of the final charging connector, where the reinforcement element is located, is more durable against mechanical stress.

According to the present disclosure, it is possible to obtain a higher resistance against shock and ruptures in specific locations of the geometry of the charging connector. Those locations are preferably locations that are mostly affected by high impact or mechanical stress.

### BRIEF DESCRIPTION OF THE SEVERAL VIEWS OF THE DRAWING(S)

FIG. 1 shows a drawing of a charging connector in accordance with the disclosure.

FIG. 2 shows a perspective drawing of a mating interface in accordance with the disclosure.

FIG. 3 shows a perspective drawing of a mating interface according to FIG. 2 with a reinforcement element.

FIG. 4 shows a different embodiment of the mating interface according to FIG. 2 with a reinforcement element.

FIG. 5 shows a different embodiment of the mating interface according to FIG. 2 with a reinforcement element.

FIG. 6 shows a different embodiment of the mating interface according to FIG. 2 with a reinforcement element.

### DETAILED DESCRIPTION OF THE INVENTION

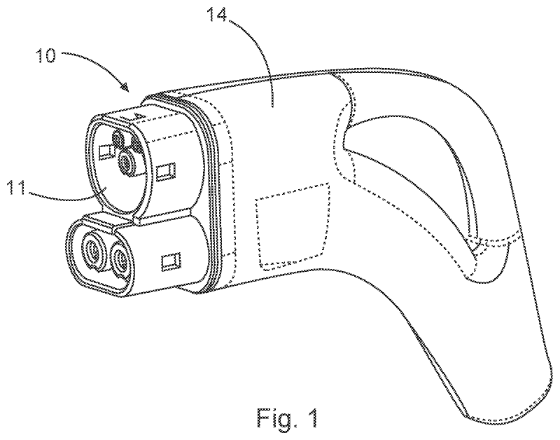

FIG. 1 shows a drawing of a charging connector 10 in its assembled state. The charging connector 10 comprises a mating interface 11 and an external enclosure 14. The mating interface 11 is arranged at a free end section of the charging connector 10. The mating interface 11 is configured to be releasable connectable to a socket of an electric vehicle.

The mating interface 11 is a mating interface 11 for a CSS (Combined Charging System) type 2 charging system. It should be made clear, that the type of the charging system is not relevant for the present disclosure. The method according to the invention is applicable to produce charging connectors or parts for charging connectors for different charging systems. The illustrated charging connector 10 and mating interface 11 are merely exemplary embodiments.

The external enclosure 14 forms a shell that encloses the electrical components of the charging connecter 10. The external enclosure 14 comprises/consists, for example, of two half shells, which are connected to each other by screws and/or latching/clipping means. Other material-, friction- or form fit-locking means are possible. The external enclosure 14 comprises a handle to hold the charging connector 10. The external enclosure 14 protects the inner components of the charging connector 10 from environmental influences. Therefore, in an embodiment (not shown), the external enclosure 14 may be partially reinforced by using the steps of the method according to the present disclosure.

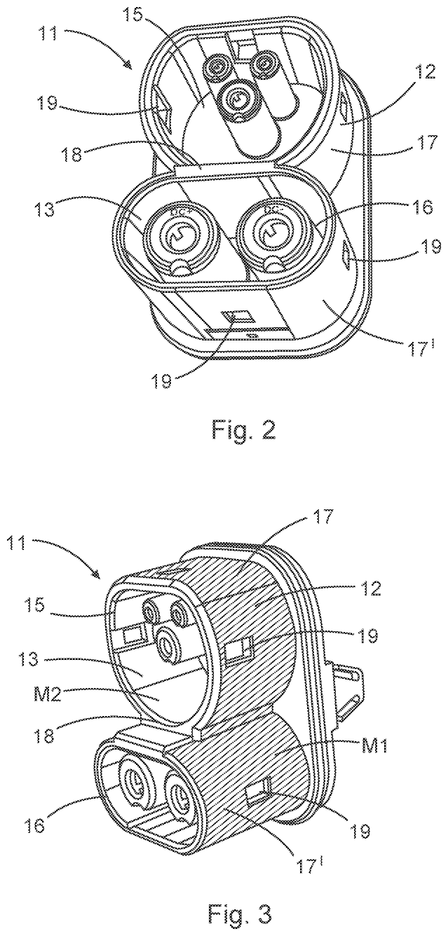

FIG. 2 shows the mating interface 11 in more detail. As mentioned above, the mating interface 11 is here a CCS type 2. The mating interface 11 has a first section 15 comprising an AC connector for charging with alternate current and a second section 16 with a DC connector for charging with direct current. The first and second sections 15, 16 are separated from each other. The first section 15 is located directly next to the second section 16.

The AC and DC connectors comprise cylindrical protrusions. Each cylindrical protrusion has a circular bore in the centre to connect with an electric charging socket.

Each section is enclosed by a collar 17, 17′. At the boundary between the first and the second section 15, 16, the collars 17, 17′ form a shared boundary wall 18.

The collars 17, 17′ of the AC and DC sections comprise recesses 19. The recesses 19 are part of a latching mechanism. A corresponding part of said latching mechanism is on the vehicle socket side, which may be a pin that is actuated when the charging connector 10 is plugged in.

FIG. 3 shows a drawing of a mating interface 11. The geometry of the mating interface 12 in FIG. 3 is identical to the geometry of the mating interface shown in FIG. 2. In FIG. 3, the outer walls 12 of the collars 17, 17′ are highlighted. The highlighted geometry corresponds to the geometry of a reinforcement element. In other words, this embodiment of the mating interface 11 comprises an over molded reinforcement element, wherein the reinforcement element had been shaped as the highlighted area. Generally, the reinforcement element may comprise one or more parts that form a desired geometry and/or multiple geometries.

The reinforcement element comprises a first thermoplastic material M1, wherein first thermoplastic material M1 may comprise for example continuous fibres. The remainder of the mating interface 11 may comprise a second thermoplastic material M2, wherein the second thermoplastic material M2 may comprise for example chopped fibres. Additionally or alternatively, the first and/or second thermoplastic material M1, M2 may be a flame retardant thermoplastic material, e.g. with a flame classification UL 94 HB or higher.

Continuous fibres in a thermoplastic material have a preferred orientation, wherein chopped fibres in thermoplastic material generally have a random orientation. The first thermoplastic composite material M1 with continuous fibres provides higher stiffness, tensile strength and fracture toughness compared to the second thermoplastic material M2. The second thermoplastic material M2 with chopped fibres may have a better surface finish and lower material costs.

The reinforcement element may be produced in an easy and cheap way by thermoforming. In this way, it is possible to produce a large number of reinforcement elements. Different reinforcement elements for different geometries of the charging connector or for different charging connectors may be provided.

The combination of the two manufacturing processes injection moulding and thermoforming offers a flexible and cost effective way to reinforce specific areas of the charging connector.

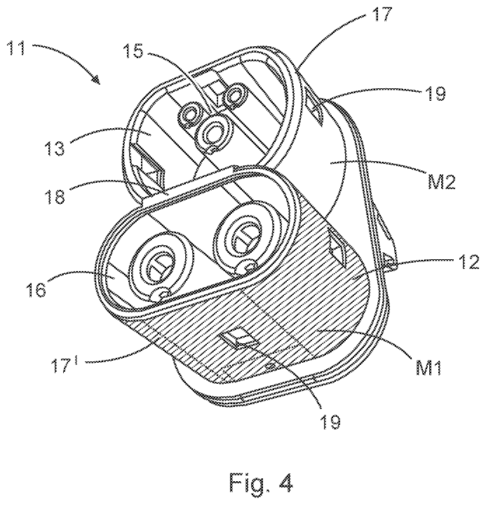

The mating interface shown in FIG. 4 is identical in geometry to the example shown in FIG. 2. In FIG. 4, the outer wall 12 of the second section 16 is highlighted. In other words, only the second section 16 comprises a reinforcement element in this embodiment. Alternatively, it may also be possible that only the first section 15 comprises a reinforcement element in the area of its outer wall 12.

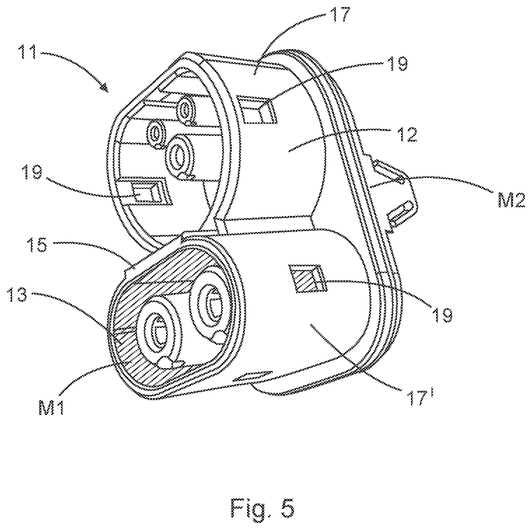

The example shown in FIG. 5 is identical in geometry to FIG. 2 and shows an embodiment where the reinforcement element is arranged at an inner wall 13 of the collar 17′ of the second section 16. Likewise, the same is possible for the first section 15.

In particular, by reinforcing the walls as shown in FIGS. 3-5, also the recesses 19 may be reinforced too. Intact recesses 19 are important to ensure a secure connection of the charging connector to a charging socket.

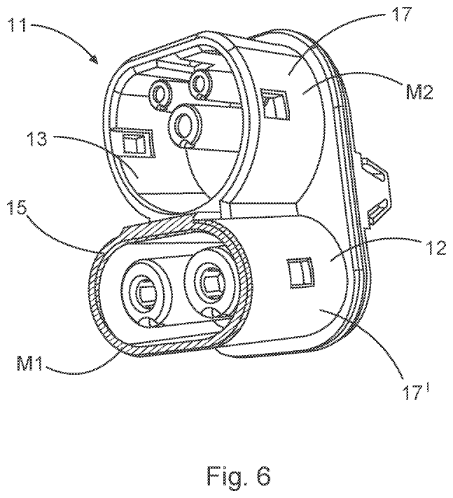

The example of FIG. 6 has the same geometry as the example shown in FIG. 2. The difference to FIG. 2 is that FIG. 6 shows an embodiment in which the edge of the collar 17′ of the second section comprises a reinforcement element. The collar 17 of the first section 15 may be reinforced in the same way.

It is clear, that combinations of the different embodiments are not excluded from the scope of the invention. For example, the edges of both collars 17 can be reinforced according to the embodiment shown in FIG. 6. Alternatively, the edge of collar 17′ of the second section 16 and the outer wall 12 of the first section 15 may be reinforced by over molded reinforcement elements.

Further, it is possible to produce other parts of the charging connector according to the steps as described. For example, the external enclosure 14 may be produced using the method as described.

In a general embodiment, provided woven sheets of continuous fibre composite are thermoformed and then placed in an injection-moulding tool prior to the injection moulding process. Then, the injection moulding process for fabricating the mating interface may be performed.

It shall be noted that all embodiments/examples of the present disclosure concerning the method might be carried out with the order of the steps as described, nevertheless this has not to be the only and essential order of the steps of the method. The herein presented methods can be carried out with another order of the disclosed steps without departing from the respective method embodiment, unless explicitly mentioned to the contrary hereinafter.

Other variations to the disclosed embodiments can be understood and effected by those skilled in the art in practicing the claimed invention, from the study of the drawings, the disclosure, and the appended claims. In the claims, the word “comprising” does not exclude other elements or steps and the indefinite article “a” or “an” does not exclude a plurality. A single processor or other unit may fulfil the functions of several items or steps recited in the claims. The mere fact that certain measures are recited in mutually different dependent claims does not indicate that a combination of these measures cannot be used to advantage. Any reference signs in the claims should not be construed as limiting the scope of the claims.

In an embodiment, the first thermoplastic material and/or the second thermoplastic material are flame retardant. In particular, the first thermoplastic material and/or the second thermoplastic material are at least flame retardant according to the flammability class UL 94 HB.

The HB flame rating indicates that a material was tested in a horizontal position (horizontal burn) and found to burn at a rate less than a specified maximum. More precisely, the burning rate is less than 76 mm/min for a thickness of a material of less than 3 mm. Alternatively, the burning stops before spreading 100 mm.

The flame retardant thermoplastic material provides an additional safety measure. This is in particular advantageous, since electrical components may also represent a fire hazard.

Other thermoplastic materials with higher flame classifications according to UL 94 may be possible. UL 94 comprises six flame classifications, which are assigned to materials based on the results of small-scale flame tests. These classifications are used to distinguish a material's burning characteristics after test specimens have been exposed to a specified test flame under controlled laboratory conditions. These classifications relate to materials commonly used in manufacturing enclosures, structural parts and insulators found in consumer electronic products (UL 94 5VA, 5VB, V-0, V-1, V-2, HB).

In an embodiment, the first thermoplastic material is a thermoplastic compo site material comprising continuous fibres and the second thermoplastic material is a thermoplastic composite material comprising chopped fibres.

Continuous fibres in a thermoplastic composite material have a preferred orientation, wherein chopped fibres in thermoplastic composite material generally have a random orientation. The first thermoplastic composite material with continuous fibres provides higher stiffness, tensile strength and fracture toughness compared to the second thermoplastic composite material. The second thermoplastic composite material with chopped fibres provides a better surface finish and lower material costs.

In an embodiment, a mating interface of the charging connecter is also produced according to the explained steps. The mating interface is the part of the charging connector, which interacts, for example, with the socket of an electric vehicle. The mating interface may be arranged at a free end of the charging connector. The mating interface is the part of the charging connector, which may be exposed the most to impacts and mechanical stress.

In an embodiment, the first thermoplastic composite material comprises glass- and/or carbon fibres. Thermoplastic composite materials with glass- and/or carbon fibres are commercially available and have good load bearing capabilities.

In an embodiment, the first thermoplastic composite material is provided in tape form, in particular as a flat woven tape. Thermoplastic material in tape form is easy to handle. In addition, thermoplastic material in tape form is commercially available and advantageous for thermoforming. The tapes may be woven into sheets with different patterns, for example, by automatic tape-placement techniques, with variations of positioning angles for the tapes at each layer, to obtain different orientations of the fibres, which may improve fracture strength and fracture toughness.

In an embodiment, the first thermoplastic material and/or the second thermoplastic material comprise a polybutylene terephthalate, PBT, plastic.

In an alternative embodiment, the first thermoplastic material and/or the second thermoplastic material comprise a polyamide plastic, in particular PA6 or PA66.

In an embodiment, the first thermoplastic material and the second thermoplastic material comprise the same base material. For example, if the base material of the first and second thermoplastic material is a polyamide material (e.g. PA6 or PA66 or similar), there is no chemical discontinuity in the final part. This may provide a good adhesive strength between the injection moulded second thermoplastic material and the thermoformed first thermoplastic material.

In an embodiment, the fibre content of the second thermoplastic composite material is between 0% to 50% (weight percentage), in particular approximately between 5% and 30% (weight percentage).

In an embodiment, the reinforcement element corresponds to the geometry of an outer wall and/or an inner wall of the charging connector, in particular, it corresponds to the mating interface. In other words, the reinforcement element is preferably used for sections of the charging connector that are part of a wall. These sections may be damaged particularly easy, for example, by dropping of the charging connector.

A further aspect of the present disclosure relates to a charging connector produced by the method described above.

In an embodiment, the charging connector is an electric vehicle (EV) charging connector. The term electric vehicle comprises all different sorts of electric vehicles.

Another aspect of the present disclosure relates to a charging connector, in particular for an electric vehicle, comprising a mating interface with at least one reinforcement element, wherein the mating interface comprises a second thermoplastic material and the at least one reinforcement element comprises a first thermoplastic material, wherein the first thermoplastic material and/or the second thermoplastic material are flame retardant and/or the first thermoplastic material is a thermoplastic composite material comprising continuous fibres and/or the second thermoplastic material is a thermoplastic composite material comprising chopped fibres. With respect to the charging connector of the present disclosure, the explanations and effects of the above method also apply correspondently.

These and other features, aspects and advantages of the present invention will become better understood with reference to the accompanying figures and the following description.

### LIST OF REFERENCE SIGNS

M1 first thermoplastic material
M2 second thermoplastic material
10 charging connector
11 mating interface
12 outer wall
13 inner wall
14 external enclosure
15 first section
16 second section
17, 17′ collar
18 boundary wall
19 recess

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method for producing a charging connector, comprising:
providing a first thermoplastic material;
thermoforming the first thermoplastic material into a reinforcement element, wherein the reinforcement element corresponds to a geometry of the charging connector;
placing the reinforcement element into a mold for injection molding; and
forming at least a part of the charging connector by injection over molding the reinforcement element with a second thermoplastic material.

2. The method according to claim 1, wherein at least one of the first thermoplastic material and/or the second thermoplastic material is/are flame retardant.

3. The method according to claim 2, wherein the at least one of the first thermoplastic material and/or the second thermoplastic material is at least flame retardant according to a flammability class UL 94 HB.

4. The method according to claim 1, wherein the first thermoplastic material is a thermoplastic composite material comprising continuous fibers and/or the second thermoplastic material is a thermoplastic composite material comprising chopped fibers.

5. The method according to claim 1, wherein the charging connector comprises a mating interface, and wherein at least the mating interface is provided with a reinforcement element.

6. The method according to claim 3, wherein the first thermoplastic material comprises glass- or carbon fibers.

7. The method according to claim 1, wherein the first thermoplastic material is provided as a flat woven tape.

8. The method according to claim 1, wherein the first thermoplastic material and/or the second thermoplastic material comprise(s) a PBT plastic.

9. The method according to claim 1, wherein the first thermoplastic material and/or the second thermoplastic material comprise(s) a polyamide plastic.

10. The method according to claim 1, wherein the first thermoplastic material and the second thermoplastic material comprise the same base material.

11. The according to claim 4, wherein the fiber content of the second thermoplastic composite material is between 0% to 50%.

12. The method according to claim 1, wherein the reinforcement element corresponds to a geometry of an outer wall and/or an inner wall of the charging connector.

13. The method of claim 12, wherein the geometry is a mating interface.

14. The method of claim 1, wherein the charging connector is an electric vehicle (EV) charging connector.

15. A charging connector for an electric vehicle, comprising:
a mating interface that includes at least one reinforcement element;
wherein the mating interface comprises a second thermoplastic material and the at least one reinforcement element comprises a first thermoplastic material;
wherein the first thermoplastic material and/or the second thermoplastic material are flame retardant and/or the first thermoplastic material is a thermoplastic composite material comprising continuous fibers and/or the second thermoplastic material is a thermoplastic composite material comprising chopped fibers.
